(19) United States
(12) Patent Application Publication
(10) Pub. No.: US 2019/0077194 A1
(43) Pub. Date: Mar. 14, 2019

(54) REINFORCEMENT LAYER FOR A PNEUMATIC VEHICLE TIRE, PREFERABLY FOR A BELT BANDAGE LAYER OF A PNEUMATIC VEHICLE TIRE

(71) Applicant: Continental Reifen Deutschland GmbH, Hannover (DE)

(72) Inventors: Wolfgang Reese, Peine (DE); Thomas Kramer, Herford (DE)

(21) Appl. No.: 16/085,470

(22) PCT Filed: Dec. 20, 2016
(86) PCT No.: PCT/EP2016/081821

§ 371 Date: Sep. 14, 2018

(30) Foreign Application Priority Data
Mar. 17, 2016 (DE) 10 2016 204 423.0

(51) Int. Cl. B60C 9/00; D01F 6/60; D02G 3/48

(52) U.S. Cl. CPC B60C 9/0042; B60C 2009/2257; D02G 3/48; D01F 6/60

(57) ABSTRACT

The invention relates to a reinforcement ply for a pneumatic vehicle tire, preferably for a belt bandage ply of a pneumatic vehicle tire, where the reinforcement ply has strengthening elements comprising at least one multifilament yarn, and where the at least one multifilament yarn is composed of polyamide based mainly on renewable raw materials. For the conservation of the environment and resources, coupled with improved product quality, the multifilament yarn consists of nylon-4,10.

### CROSS REFERENCE TO RELATED APPLICATIONS

This application is a continuation application of international patent application PCT/EP2016/081821, filed Dec. 20, 2017, designating the United States and claiming priority from German application 10 2016 204 423.0, filed Mar. 17, 2016, and the entire content of both applications is incorporated herein by reference.

### FIELD OF THE INVENTION

The invention relates to a reinforcement ply for a pneumatic vehicle tire, preferably for a belt bandage ply of a pneumatic vehicle tire, where the reinforcement ply has strengthening elements comprising at least one multifilament yarn, and where the at least one multifilament yarn is composed of polyamide based mainly on renewable raw materials.

### BACKGROUND OF THE INVENTION

Such a reinforcement ply is known from US2013/0240105, the entire contents of which are incorporated herein by reference. For conservation of the environment and resources, coupled with good product quality, a strengthening element containing nylon-10,10 is used in the reinforcement ply. Nylon-10,10 is a polycondensation product of decamethylene-1,10-diamine and decane-1,10-dioic acid, both monomers being obtained from castor oil. Thus, nylon-10,10 is 100% based on natural, renewable raw materials and not on mineral oil.

Reinforcement plies for pneumatic vehicle tires and the strengthening elements thereof are known to the person skilled in the art in a wide variety of different configurations in terms of construction and material.

In pneumatic vehicle tires, yarns or cords are used in the bead region, as carcass material, for belt plies and as belt bandage. During the production of the tire, the yarns or cords are embedded into a rubber mixture in order to be able to be usable as a rubberized strengthening element ply in the tire.

The belt bandage in pneumatic vehicle tires, especially in the case of high-speed use, contributes to preventing lifting of the tire as a result of the centrifugal forces that occur in driving operation. In a pneumatic vehicle tire, which generally has an impervious inner layer, a radial carcass comprising strengthening elements which extends from the crown region of the tire through the sidewalls into the bead region where it is usually anchored by entangling of bead cores of high tensile strength, a radially outward rubber tread having profile grooves and a belt between the rubber tread and the carcass, it is arranged between the belt and tread. The belt bandage may have one or more plies, covers at least the edges of the belt and contains strengthening elements running parallel and essentially in circumferential direction in the form of cords embedded into a rubber mixture. In tire production, the belt bandage is applied in the form of plies with strengthening elements embedded into an unvulcanized rubber mixture, which are wound or coiled on the belt. Strengthening elements for such plies are embedded into rubber in that an array of essentially parallel strengthening elements in the form of threads, which have generally been subjected to pretreatment by thermal means and/or with an impregnation in a manner known to the person skilled in the art for better adhesion to the embedding rubber, run through a calender or an extruder in longitudinal direction for ensheathing with the rubber mixture. In the course of shaping with tire construction apparatus used to date and vulcanization of the tire, the tire, as a result of the lifting, generally stretches by up to 2% in the shoulder region and by up to 4% in the middle region compared to the unvulcanized green tire when the green tire is wound on a flat drum. Thus, the strengthening element used in the belt bandage should advantageously permit this lifting, but likewise have suitable shrinkage characteristics during the vulcanization of the tire to at least press the edges of the belt down.

Materials used to date for strengthening elements in reinforcement plies, especially in belt bandages of pneumatic vehicle tires, have firstly been textile strengthening elements based primarily (directly) on fossil raw materials (on mineral oil), for example PET (polyethylene terephthalate), aramid and nylon, or hybrid cords made from the yarns thereof. On the other hand, the use of non-mineral-oil-based textile strengthening elements made from rayon or lyocell is known. These are synthetic fibers made from natural polymers, namely cellulose.

To conserve the environment and resources, efforts are being made to reduce the proportion of raw materials based on mineral oil, such as synthetic fibers, in elastomer products. At the same time, however, the properties demanded from the product are not to be impaired.

However, the use of natural fibers such as cotton in the rubber industry is limited in that they do not have a continuous fiber structure and have a highly variable fiber quality. The lack of shrinkage characteristics of natural fibers additionally makes them unsuitable for use as strengthening elements in belt bandages of pneumatic vehicle tires.

Nylon-10,10 conserves resources since it is 100% obtainable from natural renewable raw materials, but the properties of a strengthening element made from nylon-10,10 in the belt bandage ply of a pneumatic vehicle tire are in need of improvement.

Two properties of the strengthening element are particularly desired in this context: firstly, the polyamide material is to have such good stretchability that an advantageous high shrinkage is obtainable; secondly, the modulus should be within an advantageously high range.

Nylon-10,10 which has long and soft chains in the acid and diamine components has comparatively good stretchability and therefore has a desirable high shrinkage, but a comparatively disadvantageously low modulus.

Nylon-6,6 has moderate chain lengths in the acid and diamine component, likewise still has good stretchability and therefore still has suitable shrinkage and a suitable modulus, but is not producible in an environmentally conserving and resource-conserving manner.

Nylon-4,4 has comparatively poor stretchability owing to its short chain lengths in the acid and diamine component and therefore has disadvantageous low shrinkage if anything, but has an advantageous high modulus.

### SUMMARY OF THE INVENTION

It is an object of the invention to provide a reinforcement ply with strengthening elements for a pneumatic vehicle tire, preferably for a belt bandage ply of a pneumatic vehicle tire, the polyamide multifilament yarns of which conserve the environment and resources and which further improve the product in terms of its quality.

The object is achieved in accordance with the invention in that the multifilament yarn consists of nylon-4,10.

This provides a partly biobased multifilament yarn consisting of nylon-4,10. One monomer from the two monomers of nylon-4,10 is based mainly on renewable raw materials and not on mineral oil and is thus environmentally friendly and benign in terms of resources. Polyamides are polycondensation products formed from dicarboxylic acids and diamines. An economically important dicarboxylic acid is sebacic acid, which is produced, for example, from castor oil, obtained from the seeds of the castor oil plant. The “10” component of nylon-4,10 is based on sebacic acid.

The environmentally friendly character is also emphasized in that the castor oil plants are grown under conditions under which they do not compete with other useful plants. In addition, nylon-4,10 fibers have a consistent quality compared to natural fibers and are producible as continuous fibers. It is thus possible to ensure consistent product quality and processing reliability.

### DESCRIPTION OF THE PREFERRED EMBODIMENTS OF THE INVENTION

Polyamide-4,10 features a polymer structure having good stretchability and suitably high shrinkage at a suitable modulus. By comparison with the other polyamides, nylon-4,10 is thus a good compromise between shrinkage and modulus, which is particularly suitable for use as a strengthening element in a belt bandage ply.

Moreover, nylon-4,10 is notable for low water absorption capacity, which means that the good properties such as breaking strength are obtained in the presence of moisture as well.

It is additionally advantageous that nylon-4,10 has great similarity to nylon-6,6, which is frequently used in reinforcement plies. In this way, easy exchange of nylon-6,6 (PA 6,6) for nylon-4,10 (PA 4,10) is possible with retention, for example, of the bonding system used.

The table which follows shows the advantageous properties of PA 4,10 multifilament yarns over PA 6,6 multifilament yarns.

| | Dtex | Shrink- | Tenacity | Elonga- | Load@ 4% |
|---|---|---|---|---|---|
| | [g/ | age | [cN/ | tion@Break | Elongation |
| | 1000 m] | [%] | tex %] | [%] | [cN/tex] |
| PA 6,6 | 1400 | 6 | 75 | 18 | 11.9 |
| PA 4,10 | 1400 | 8 | 79 | 16 | 11.5 |

The values are measured on an untwisted yarn.

Shrinkage is determined according to ASTM D885 and ASTM D4974.

The force/elongation data are determined according to ASTM D855M.

In one embodiment of the invention, the strengthening element is an end-twisted cord made from at least two twisted multifilament yarns. The twisting of the multifilament yarn or the cord achieves an improvement in fatigue resistance of the strengthening element by comparison with untwisted strengthening elements.

It is appropriate when the multifilament yarn has a fineness of 100 to 5000 dtex and a twist rate of 100 to 600 t/m. Multifilament yarns of this kind can be produced in a simple manner and are suitable for use as strengthening elements in pneumatic vehicle tires.

It is advantageous when the cord consists of 2 or 3 end-twisted multifilament yarns.

In a particular version of the invention, all multifilament yarns of the cord consist of nylon-4,10.

In an alternative version of the invention, one multifilament yarn of the cord does not consist of nylon-4,10. But it is also possible that at least one multifilament yarn of the cord does not consist of nylon-4,10. In that case, the cord is what is called a hybrid cord. This is then based at least partly on renewable raw materials, is configured in a resource-conserving manner and offers, as a further advantage, the option of defined adjustment of the cord via a specific material selection of the yarn that does not consist of nylon-4,10.

The invention likewise relates to a pneumatic vehicle tire having a reinforcement ply as per a reinforcement ply detailed above. This reinforcement ply is a belt bandage ply or a bead reinforcement, such as a chipper or a flipper.

Pneumatic vehicle tires are mass-produced products where partial exchange of mineral oil-based materials for materials not based on mineral oil leads to a particularly major effect with regard to conservation of resources. Moreover, it has been shown that reinforcement plies comprising strengthening elements composed of multifilament yarns of nylon-4,10 lead to high durability in the tire.

A car tire may, for example, have a belt bandage ply made of cords of the following construction:

Variant A: Construction/material: 1400×1/nylon-4,10
End twisting: 100 t/m
   Variant B: Construction/material: 940×2/nylon-4,10
End twisting: 350 t/m

In the case of cords, that is, in the case of strengthening elements having two or more multifilament yarns, the yarn twisting is equal to the cord twisting, but in the opposite direction.

It is understood that the foregoing description is that of the preferred embodiments of the invention and that various changes and modifications may be made thereto without departing from the spirit and scope of the invention as defined in the appended claims.

1-8. (canceled)

9. A pneumatic vehicle tire reinforcement ply, comprising strengthening elements that comprise at least one multifilament yarn, wherein the multifilament yarn comprises nylon-4,10 sourced from plant material.

10. The reinforcement ply of claim 9, wherein the reinforcement ply is a belt bandage ply.

11. The reinforcement ply of claim 10, wherein the belt bandage ply comprises 1400×1 or 940×2 nylon-4,10.

12. The reinforcement ply of claim 11, wherein the 1400×1 nylon-4,10 is end twisted at 100 t/m, and wherein the 940×2 nylon-4,10 is end twisted at 350 t/m.

13. The reinforcement ply of claim 10, wherein the pneumatic vehicle tire further comprises:
a crown region,
two sidewalls,
a bead region comprising one or more bead cores,
an impervious inner layer,
a radial carcass comprising the strengthening elements extending from the crown region through the sidewall and into the bead region, wherein the strengthening elements are anchored by entangling of the bead cores, and
a radially outward rubber tread comprising profile grooves,
wherein the belt bandage is arranged between the rubber tread and the radial carcass.

14. The reinforcement ply of claim 9, wherein one monomer of the nylon-4,10 is sourced exclusively from plant materials.

15. The reinforcement ply of claim 9, wherein the nylon-4,10 comprises no synthetic fibers.

16. The reinforcement ply of claim 14, wherein the one monomer is produced by a process of:
obtaining castor oil from seeds of a castor oil plant,
obtaining sebacic acid from the castor oil,
reacting the sebacic acid and a diamine in a polycondensation reaction.

17. The reinforcement ply of claim 9, wherein the strengthening element is an end-twisted cord comprising at least two twisted multifilament yarns.

18. The reinforcement ply of claim 17, wherein the multifilament yarn has a fineness of 100 to 5000 dtex and a twist rate of 100 to 600 t/m.

19. The reinforcement ply of claim 17, wherein the cord consists of 2 or 3 end-twisted multifilament yarns.

20. The reinforcement ply of claim 9, wherein all of the multifilament yarns consist of nylon-4,10.

21. A pneumatic vehicle tire, comprising the reinforcement ply of claim 9.

22. The pneumatic vehicle tire of claim 21, wherein the reinforcement ply is a belt bandage ply or a bead reinforcement.

23. A method of manufacturing a pneumatic vehicle tire reinforcement ply, which comprises:
growing a castor oil plant so that it produces seeds,
harvesting the seeds from the castor oil plant,
extracting castor oil from the seeds,
producing sebacic acid from the castor oil,
reacting the sebacic acid with a diamine in a polycondensation reaction to create nylon-4,10,
creating a multifilament yarn from the nylon-4,10,
twisting at least two multifilament yarns together to create a cord, and
embedding one or more nylon-4,10 cords into a rubber mixture to create a reinforcement ply.

24. The method of claim 23, wherein the multifilament yarn has a fineness of 100 to 5000 dtex and a twist rate of 100 to 600 t/m.

25. The method of claim 23, wherein the cord comprises 2 or 3 end-twisted multifilament yarns.

26. The method of claim 23, wherein the reinforcement ply is a belt bandage ply comprising cords that comprise 1400×1 or 940×2 twisted nylon-4,10 yarns.
